(19) United States
(12) Patent Application Publication
(10) Pub. No.: US 2003/0220139 A1
(43) Pub. Date: Nov. 27, 2003

(54) Gambling machine winning information viewing system

(76) Inventor: Frederick C. Peterson, Sammamish, WA (US)

Correspondence Address: Dean A. Craine, P.S., Suite 140, 400 - 112th Ave. NE, Bellevue, WA, 98004, US

(21) Appl. No.: 10/153,765

(22) Filed: May 21, 2002

(51) Int. Cl. A63F 13/00

(52) U.S. Cl. 463/30

(57) ABSTRACT

An improved gambling machine winning information viewing system that uses a gambling machine coupled to a video display monitor mounted or suspended at an elevated, remote location in a casino that displays current or historical jackpot winning information from the gambling machine. The display monitor may be coupled to a single gambling machine or to a plurality of gambling machines. The display monitor may be individually mounted or mounted in a bank or group of monitors. The gambling machine may also transmit identification and location information to the display monitor so that the exact identification and location of the gambling machine may be determined by the customers. The gambling machines may be attached to an optional control unit that controls which gambling machine's jackpot winning information is displayed.

### BACKGROUND OF THE INVENTION

1. Field of the Invention

This invention relates to visual display systems, and more particularly, to such systems used in a casino or gambling facility to display the activities of gambling machines in the casino to their existing and potential customers.

2. Description of the Related Art

Gambling machines in casinos, typically have lit front and side panels and bells that are activated to a higher level when a jackpot is won. The level of activation of the machine's lights and bells often varies depending on the size of the jackpot. The general purpose activating the panels and bells to a higher level when a jackpot is won is to create a localized exciting atmosphere for the customers that positively reinforce their visit to the casino. In some instances, activating the panels and bells also informs casino personnel that a customer has just won a large jackpot at a particular machine.

One drawback with gambling machines found in the prior art is that non-playing customers located away from the winning machine are unable to determine which particular gambling machine just awarded a jackpot and the size of the jackpot. Another drawback is that new customers are unable to determine how many jackpots a particular machine has recently awarded.

Obviously, most customers look for gambling machines that award a relatively high number of jackpots. Some customers look for machines that frequently award small jackpots while other customers look for machines that award less frequent, large jackpots. Regardless of the preference, the historical jackpot awarding information of the gambling machines in a casino would be desirable to most customers.

The success of a casino is dependent in part, upon its ability to attract customers and distinguish itself from other casinos. As a result, casinos are constantly refurbished with new games and gambling machines being introduced.

What is needed is a novel method of attracting customers into a casino by widely displaying real time jackpot winning information for its gambling machines to customers.

### SUMMARY OF THE INVENTION

A novel system and method for attracting customers into a casino by widely displaying real time jackpot winning information from its gambling machines. The system and method comprises a plurality of gambling machines coupled to an elevated, remotely located display means that displays the gambling machine's individual jackpot winning information to customers for general viewing. The display means is coupled to the gambling machine's gambling control unit that receives and collects the machine's current or historical jackpot winning information. One display means may be couple to one gambling machine or to a plurality of gambling machines. The gambling control unit collects the machine's jackpot winning information which may include the time and date of the last awarded jack pot or a sum of jackpots awarded in a selected period, and transmits it to the display means. The gambling machines identification and location within the casino may also be displayed on the display means.

In one embodiment, the display means is a video monitor formed in a bank or group of video monitors individually coupled to one gambling machine and suspended from an elevated surface located inside or outside the casino. In other embodiment, the display means is a video projector mounted on the gambling machine that illuminates the jackpot winning information onto an elevated, remotely located viewing screen.

In still another embodiment, the system includes a central collection unit that receives and collects jackpot winning information from a plurality of gambling machines and then presents to a single or multiple display means located inside or outside the casino.

### DESCRIPTION OF THE DRAWINGS

FIG. 1 is perspective view of a first embodiment of the multiple gambling machine winning display system disclosed herein in which the individual gambling machines are individually connected to a display monitor located in a flat ceiling mounted bank of display monitors.

FIG. 2 is a perspective view of a second embodiment of the system in which each gambling machine includes a video projector that broadcasts through the air an image of the jackpot winning information to a flat, ceiling mounted viewing screen.

FIG. 3 is a side elevational view of a gambling machine with a gambling control unit, a motherboard and video card connected thereto, a display cable connected to the video card, and an optional video projector located on the top surface of the gambling machine.

FIG. 4 is an illustration of a flat bank of display monitors with each display monitor connected to one gambling machine.

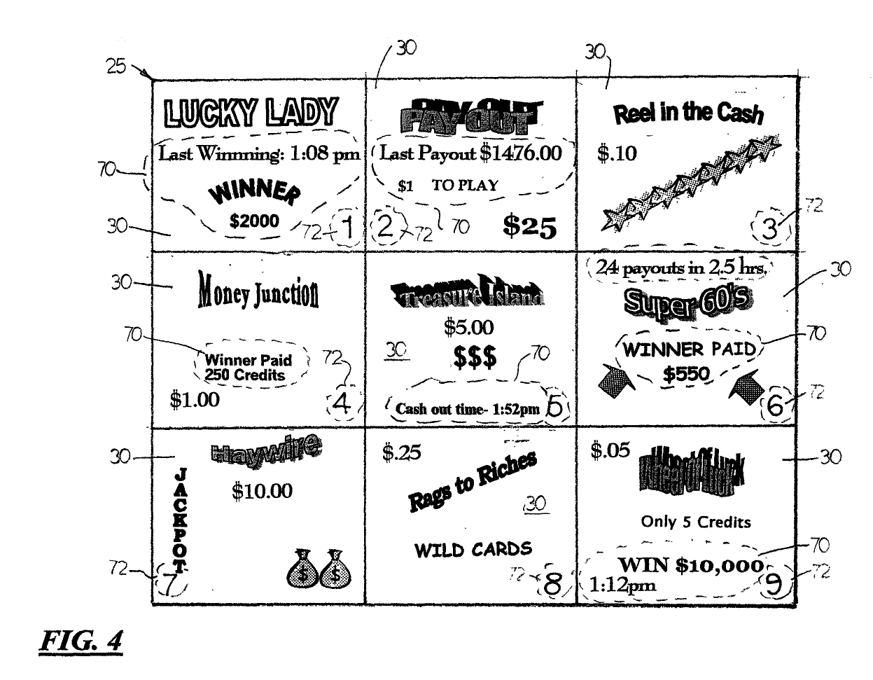

FIG. 5 is a perspective view of system showing a plurality of display monitors located in a suspended multiple face back of display monitors.

FIG. 6 is another embodiment of the invention of the system that uses a central receiver to collect jackpot winning information from a plurality of gambling machines then transmits the information to a billboard with four multiple display groupings each with multiple display monitors assigned to a gambling machine.

### DESCRIPTION OF THE PREFERRED EMBODIMENT(S)

An improved gambling machine winning information viewing system 10 that comprises at least one gambling machine 20 coupled to a viewing display means mounted or suspended from an elevated surface, such as the ceiling 90, that displays jackpot winnings information generally denoted as 70, received from the gambling machine 20. In the first embodiment, the viewing display means is a video display monitor 30 coupled to a gambling machine's control unit 35 located inside the gambling machine 20. The gambling machine's central control unit 35 collects jackpot winning information 70 and adds the time and date of the last jackpot awarded and the number of jackpots awarded within a selected time period and their amounts. In the preferred embodiment, the control unit 35 also transmits optional gambling machine identification generally denoted 72, and transmits it into the viewing display means.

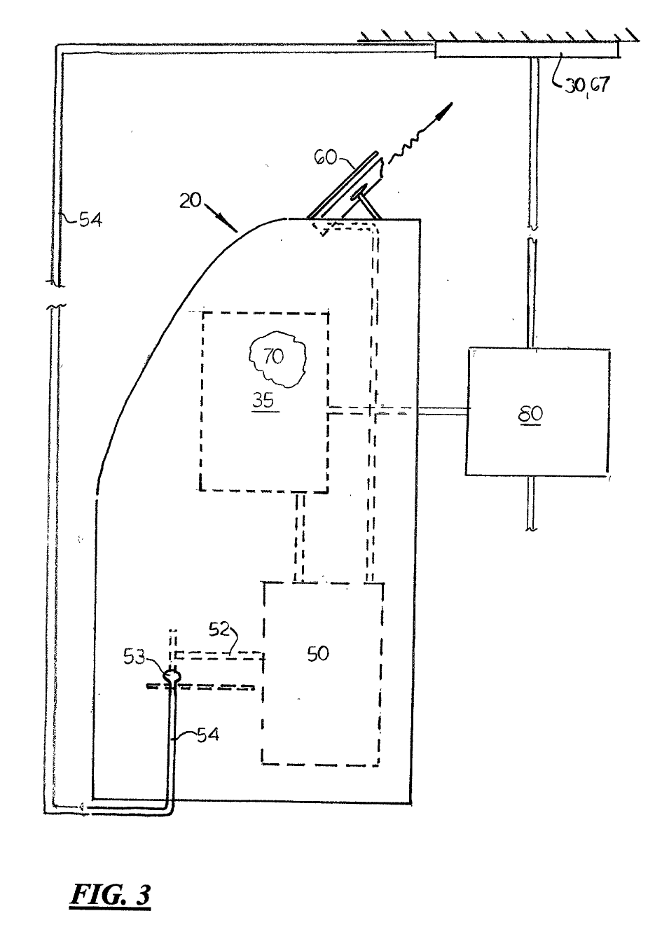

Each gambling machine 20 includes means to transmit the jackpot winning information 70 from the gambling control unit 35 to the video display monitor 30. In the preferred embodiment shown in FIG. 3, the means is a video card 52 connected to a motherboard 50 coupled to the gambling control unit 35. The video card 52 includes a data port 53 that connects to a standard display cable 54 that connects at its opposite end to the video display monitor 30. The video display monitor 30 may be a standard cathode or LCD video monitor that is compatible with the video display card 52 and cable 54.

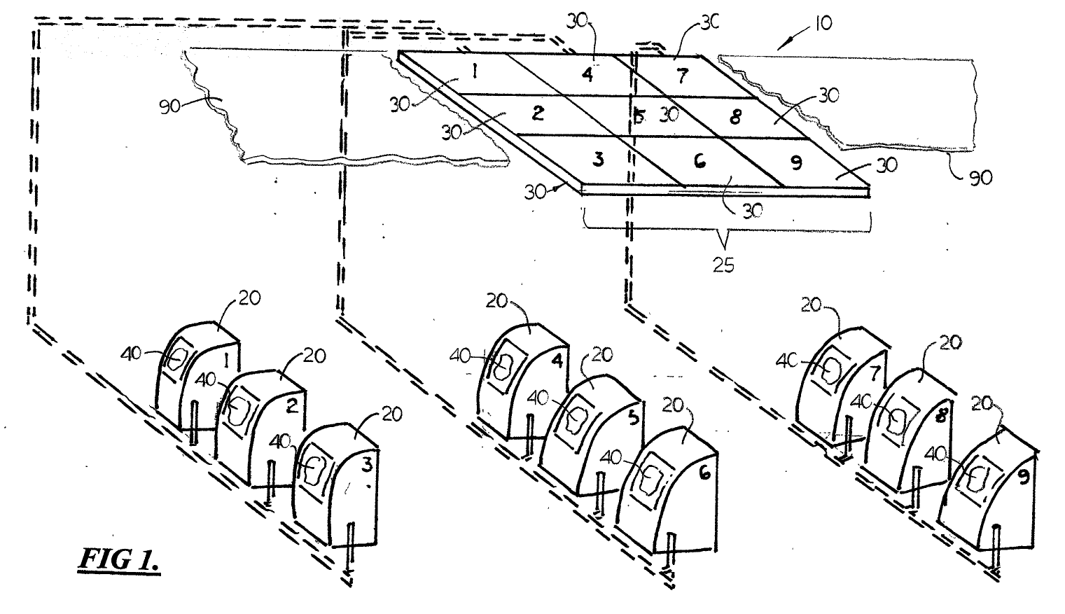

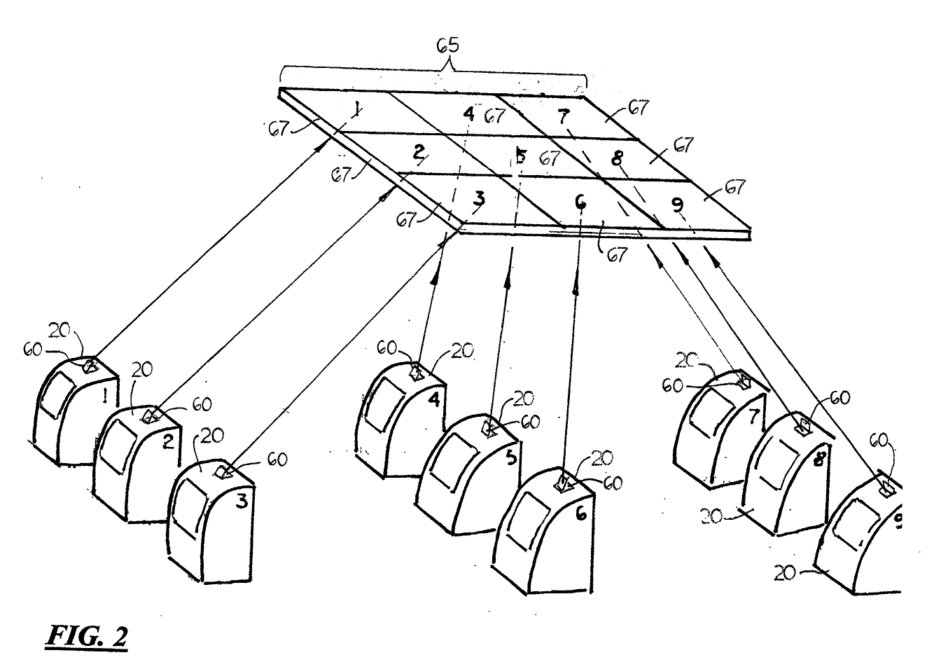

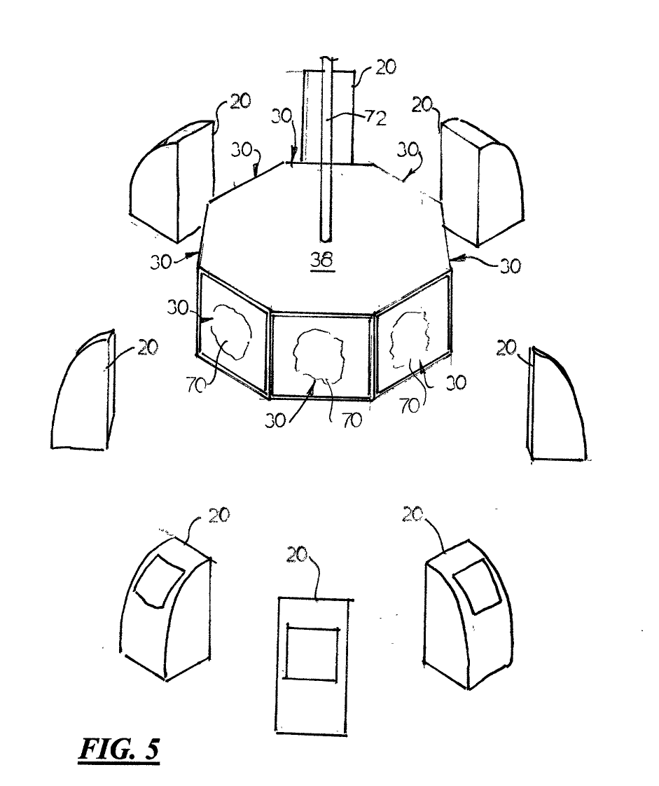

As mentioned above, each display monitor 30 may be coupled to one or a plurality of gambling machines 20. The display monitors 30 may be individually mounted at an elevated, remote position inside or outside the casino or mounted in a flat bank (denoted 25) of display monitors 30, as shown in FIG. 2, mounted inside or outside the casino. All of the displays 30 in the bank 25 may be coupled to one gambling machine 20 or to different gambling machines 20, as shown in FIG. 1. The bank 25 of display monitors 30 may also be in a flat structure 35, as shown in FIGS. 1-2, or into a multi-sided housing structure denoted 38, as shown in FIG. 5.

In another embodiment shown in FIGS. 2 and 3, the video card 52 and video display monitor 30 are replaced with an LCD projector 60 and an elevated, remotely located viewing screen 65. The LCD projector 60 is connected to the gambling control unit 35 and is designed to receive image files therefrom. The LCD projector 60 is aimed and focused to transmit through the air images of the winning jackpot information 70 onto a viewing screen 67 located in the preferred embodiment in a bank 65 of viewing screens. It should be understood that other communication links, such as a wireless transmitter and receiver, laser, or video cassette tape machines may be used in place of the standard video display card and display.

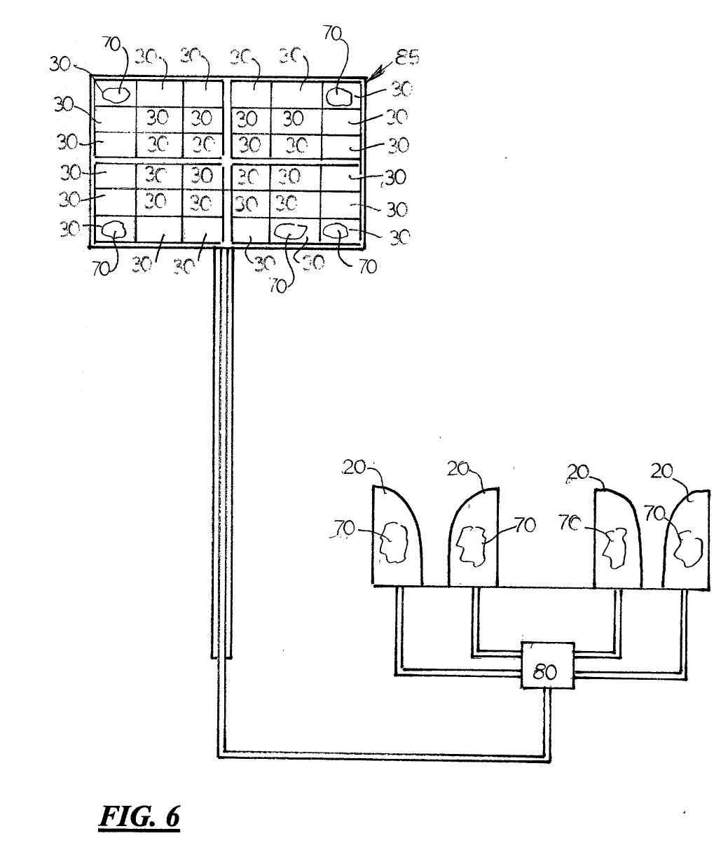

As shown in FIGS. 3 and 6, the central units 35 in each gambling machine 20 maybe connected to a central receiver 80 that collects the jackpot winning information 70 from a plurality of gambling machines 20. The receiver unit 80 is connected to a display board 85 located inside or outside the casino with a plurality of display monitors 30 located thereon that selectively display jackpot winning information 70 from the gambling machines 20. The casino operator is able to control the central receiver 80 so that only gambling machines 20 that have jackpot winnings at a pre-determined level or only gambling machines 30 located in certain areas of the casino are displayed.

In compliance with the statute, the invention described herein has been described in language more or less specific as to structural features. It should be understood, however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A gambling machine winning information viewing system for a casino, comprising:
a. a gambling machine with a gambling control unit, said gambling control unit able to collect jackpot winning information;
b an elevated, remote visual display means connected to said gambling control unit, and;
c. a remote display used to receive said jackpot winning information from said visual display means.

2. The gambling machine winning information viewing system as recited in claim 1, wherein said remote visual display means is an elevated video monitor coupled to said gambling control unit.

3. The gambling machine winning information viewing system as recited in claim 2, wherein said jackpot winning information includes the amount of a jackpot awarded by said gambling machine.

4. The gambling machine winning information viewing system as recited in claim 2, wherein said winning information includes the number of jackpots awarded in a selected time period by said gambling machine.

5. The gambling machine winning information viewing system as recited in claim 2, wherein said video monitor is suspended from the ceiling in said casino.

6. The gambling machine winning information viewing system as recited in claim 2, wherein said video monitor is coupled to said gambling control units located in a plurality of said gambling machines.

7. The gambling machine winning information viewing system, as recited in claim 2, wherein said video monitor is located in bank of video monitors with each said video monitor being coupled to one said gambling control unit.

8. The gambling machine winning information viewing system as recited in claim 7, wherein said bank of video monitors is suspended from the ceiling in said casino.

9. The gambling machine winning information viewing system as recited in claim 7, further including a central receiver connected to said bank of video monitors that controls the jackpot winning information displayed.

10. The gambling machine winning information viewing system as recited in claim 6, wherein said winning information includes the number of jackpots awarded in a selected time period by said gambling machine.

11. The gambling machine winning information viewing system as recited in claim 6, wherein said jackpot winning information includes the identification of said gambling machine.

12. The gambling machine winning information viewing system, as recited in claim 1, wherein said remote visual display means is a video projector coupled to video output port located on said gambling control unit and an elevated viewing surface used to display the image from said video projector.

13. The gambling machine winning information viewing system as recited in claim 12, wherein said winning information includes the amount of a jackpot awarded by said gambling machine.

14. The gambling machine winning information viewing system as recited in claim 12, wherein said winning information includes the number of jackpots awarded in a selected time period by said gambling machine.

15. The gambling machine winning information viewing system as recited in claim 12, wherein said viewing surface is suspended from the ceiling in said casino.

16. A gambling machine winning information viewing system for a casino, comprising:
a. a plurality of gambling machines located in a casino each with gambling control unit used to display jackpot winning information, and a video display port connected to said gambling control unit;
b at least one elevated, remotely located video display coupled to said video display port to receive jackpot award information from at least one gambling control unit; and,
c, means to selectively control the displaying of said jackpot winning information on said display.

17. The gambling machine winning information viewing system as recited in claim 16, wherein said jackpot award information includes the amount of a jackpot awarded by each said gambling machine.

18. The gambling machine winning information viewing system as recited in claim 17, wherein said jack pot award information includes the number of jackpots awarded in a selected time period by said gambling machine.

19. The gambling machine winning information viewing system as recited in claim 16, wherein said bank of video monitors is suspended from the ceiling in said casino.

20. A gambling machine winning information viewing system for a casino, comprising:
a. a plurality of gambling machines located in a casino each with gambling control unit used to display jackpot award information, and a video display port connected to said gambling control unit; and,
b. a video projector coupled to said video output port located on said gambling control unit and an elevated, remotely located viewing surface used to display the image from said video projector.
